(19) United States
(12) Patent Application Publication
(10) Pub. No.: US 2019/0346589 A1
(43) Pub. Date: Nov. 14, 2019

(54) MARINE DATA COLLECTION APPARATUS, MARITIME IOT DEVICE, AND MARINE DATA TRANSMISSION METHOD

(71) Applicant: Electronics and Telecommunications Research Institute, Daejeon (KR)

(72) Inventors: Woo-Sung JUNG, Ulsan (KR); Dae-Seung YOO, Ulsan (KR); Tae-Hyun YOON, Ulsan (KR)

(73) Assignee: Electronics and Telecommunications Research Institute, Daejeon (KR)

(21) Appl. No.: 16/396,952

(22) Filed: Apr. 29, 2019

(30) Foreign Application Priority Data
May 10, 2018 (KR) 10-2018-0053840

(51) Int. Cl. G01W 1/00; H04Q 9/00; H04L 29/08; H04W 72/04; H04W 76/10

(52) U.S. Cl. CPC G01W 1/00; H04Q 9/00; H04L 67/12; H04Q 2209/40; H04W 76/10; G01W 2001/006; H04W 72/0446

(57) ABSTRACT

Disclosed herein are a marine data collection apparatus, a maritime IoT device, and a marine data transmission method. The maritime IoT device includes a marine data collection unit for collecting marine data including at least one of ocean state information and service application data using one or more sensors, a phase information calculation unit for analyzing the collected marine data and then generating phase information and period information of waves, a communication schedule management unit for generating communication-scheduling information including communication-available time information, which indicates a time during which communication with a marine data collection apparatus is available, based on the phase information and the period information, and a communication unit for transmitting the marine data including at least one of the ocean state information and the service application data to the marine data collection apparatus during the communication-available time.

### CROSS REFERENCE TO RELATED APPLICATION

This application claims the benefit of Korean Patent Application No. 10-2018-0053840, filed May 10, 2018, which is hereby incorporated by reference in its entirety into this application.

### BACKGROUND OF THE INVENTION

### 1. Technical Field

The present invention relates generally to marine data transmission/reception technology for a maritime Internet-of-Things (IoT) device and a marine data collection apparatus, and more particularly, to technology for stably transmitting/receiving marine data in consideration of the movement of waves on the sea on which a maritime IoT device is located.

### 2. Description of the Related Art

Maritime Internet-of-Things (IoT) devices used in a marine environment periodically transfer various types of data including environmental data to a data collection apparatus. Here, such a maritime IoT device may include a sensor module for collecting and monitoring information, a microcontroller unit (MCU) module for processing the information, a power supply module for supplying power, and a communication module for transmitting/receiving the collected information.

The communication module of the maritime IoT device mainly utilizes wireless communication rather than wired communication due to environmental constraint factors of the maritime IoT device, which is installed at sea. Recently, requirements for small-sized maritime IoT devices have rapidly increased so that the maritime IoT devices can be installed and operated on buoys or fishing nets, and functions enabling small-sized maritime IoT devices to stably perform data transmission are required.

In a marine environment, compared to a communication method used in a terrestrial environment, facilities such as base stations cannot be easily installed. Due thereto, for wireless communication in a marine environment, relatively long-range communication is widely used. However, unlike a terrestrial environment, in which communication is performed at a fixed location, in a maritime environment, communication performance is deteriorated due to wind or the movement of waves.

As methods for solving the problem of deterioration of communication performance in a marine environment, a posture maintenance device may be applied. However, maritime IoT devices, which are required to be implemented at a small size, are generally installed and operated using antennas without having a posture maintenance function due to physical constraint factors.

Therefore, in order to construct a stable communication environment for maritime communication, there is required the development of technology that enables data to be stably transmitted/received even when an antenna having no posture maintenance function is applied.

Also, maritime IoT devices, which are difficult to supply with power from a separate power source, are supplied with power using a battery. Even if maritime IoT devices are equipped with rechargeable equipment, there is a limitation in that it is difficult to supply sufficient energy, and thus high-efficiency energy management technology is required.

Energy-saving technology in conventional wireless communication methods does not consider the likelihood of success in communication occurring in a marine environment, and thus the development of technology that has high energy efficiency while providing stable communication in the marine environment is required.

In connection with this, Korean Patent Application Publication No. 10-2016-0105065 discloses a technology related to “System and method for transmitting oceanic environment observation data in real time by using drifting buoy”.

### SUMMARY OF THE INVENTION

Accordingly, the present invention has been made keeping in mind the above problems occurring in the prior art, and an object of the present invention is to solve the problem of deterioration of communication performance attributable to wind or the movement of waves in a marine environment and construct a stable maritime communication environment.

Another object of the present invention is to support stable communication of a maritime IoT device and improve the energy efficiency of the maritime IoT device.

A further object of the present invention is to dynamically determine a method for accessing a communication medium depending on the state of a marine environment and to perform communication scheduling.

Yet another object of the present invention is to allow maritime IoT devices that do not have a wave-monitoring function and a communication-scheduling function to perform data transmission/reception suitable for a marine environment in which the movement of waves is great.

Still another object of the present invention is to efficiently manage the energy of a maritime IoT device by setting the communication schedule of the maritime IoT device.

In accordance with an aspect of the present invention to accomplish the above objects, there is provided a maritime Internet-of-Things (IoT) device, including a marine data collection unit for collecting marine data including at least one of ocean state information and service application data using one or more sensors, a phase information calculation unit for analyzing the collected marine data and then generating phase information and period information of waves, a communication schedule management unit for generating communication-scheduling information including communication-available time information, which indicates a time during which communication with a marine data collection apparatus is available, based on the phase information and the period information, and a communication unit for transmitting the marine data including at least one of the ocean state information and the service application data to the marine data collection apparatus during the communication-available time.

The communication schedule management unit may determine, based on a distance to the marine data collection apparatus and height information of the marine data collection apparatus, whether the marine data collection apparatus falls within a range of a radiation angle of the maritime IoT device, and generate the communication-scheduling information based on whether the marine data collection apparatus falls within the range of the radiation angle.

The communication schedule management unit may be configured to, when the phase information of waves indicates a top and the marine data collection apparatus falls within the range of the radiation angle, determine that a corresponding time is the communication-available time.

The communication schedule management unit may be configured to compare a required transmission time, which is a time required in order to transmit the marine data, with the communication-available time after generation of the communication-scheduling information, and to fragment the marine data when the required transmission time is longer than the communication-available time.

The communication unit may transmit a first frame of the fragmented marine data during the communication-available time and transmit remaining fragmented marine data after the first frame during a communication-available time corresponding to a subsequent period.

The communication schedule management unit may generate the communication-scheduling information such that a transmission time that is a time during which the marine data is to be transmitted is located at a center of the communication-available time, or set the transmission time to a time after lapse of a guard time from the communication-available time.

The communication schedule management unit may wait for data to be received from the marine data collection apparatus for a reception-waiting time including the communication-available time.

The communication unit may send a network connection request message including the phase information and the period information to the marine data collection apparatus to which the marine data is to be transmitted, and receive a network connection permission message including at least one of location information and the height information of the marine data collection apparatus from the marine data collection apparatus.

In accordance with another aspect of the present invention to accomplish the above objects, there is provided a marine data collection apparatus, including a network interface for receiving marine data including at least one of ocean state information and service application data from a maritime Internet-of-Things (IoT) device, a phase information management unit for updating phase information and period information of waves based on the ocean state information included in the marine data, and a communication-available time management unit for generating communication-scheduling information including communication-available time information, which indicates a time during which communication with the maritime IoT device is available, based on the phase information and the period information.

The network interface may wait until a last frame of the marine data is received when the marine data is fragmented data as a result of determining, based on a frame header of the received marine data, whether the marine data is the fragmented data.

The network interface may be configured to, when the marine data is not the fragmented data or when a frame of the received marine data is a last frame, send a response message to the maritime IoT device during a communication-available time corresponding to a subsequent period.

The marine data collection apparatus may further include a communication quality monitoring unit for, when the network interface consecutively receives sample data from the maritime IoT device, monitoring communication quality of the sample data so as to estimate at least one of phase information and period information of the maritime IoT device, wherein the network interface transmits the communication-available time information of the maritime IoT device, generated by the communication-available time management unit based on at least one of the estimated phase information and period information, to the maritime IoT device.

In accordance with a further aspect of the present invention to accomplish the above objects, there is provided a marine data transmission method performed by a maritime IoT device, including collecting marine data including at least one of ocean state information and service application data using one or more sensors, analyzing the collected marine data and then generating phase information and period information of waves, generating communication-scheduling information including communication-available time information, which indicates a time during which communication with a marine data collection apparatus is available, based on the phase information and the period information, and transmitting the marine data including at least one of the ocean state information and the service application data to the marine data collection apparatus during the communication-available time.

Generating the communication-scheduling information may include determining, based on a distance to the marine data collection apparatus and height information of the marine data collection apparatus, whether the marine data collection apparatus falls within a range of a radiation angle of the maritime IoT device, and generating the communication-scheduling information based on whether the marine data collection apparatus falls within the range of the radiation angle.

Generating the communication-scheduling information may be configured to, when the phase information of waves indicates a top and the marine data collection apparatus falls within the range of the radiation angle, determine that a corresponding time is the communication-available time.

The marine data transmission method may further include comparing a required transmission time, which is a time required in order to transmit the marine data, with the communication-available time after generation of the communication-scheduling information, and fragmenting the marine data when the required transmission time is longer than the communication-available time.

Transmitting the marine data may be configured to transmit a first frame of the fragmented marine data during the communication-available time and transmit remaining fragmented marine data after the first frame during a communication-available time corresponding to a subsequent period.

Generating the communication-scheduling information may be configured to generate the communication-scheduling information such that a transmission time that is a time during which the marine data is to be transmitted is located at a center of the communication-available time or to set the transmission time to a time after lapse of a guard time from the communication-available time.

The marine data transmission method may further include waiting for data to be received from the marine data collection apparatus for a reception-waiting time including the communication-available time.

The marine data transmission method may further include sending a network connection request message including the phase information and the period information to the marine data collection apparatus to which the marine data is to be transmitted, and receiving a network connection permission message including at least one of location information and the height information of the marine data collection apparatus from the marine data collection apparatus.

In accordance with yet another aspect of the present invention to accomplish the above objects, there is provided a marine data collection method performed by a marine data collection apparatus, including receiving marine data collected by a maritime IoT device from the maritime IoT device, updating phase information and period information of waves based on the marine data, generating communication-scheduling information including communication-available time information, which indicates a time during which communication with a marine data collection apparatus is available, based on the phase information and the period information, and sending a response message to the maritime IoT device during the communication-available time.

The marine data connection method may further include determining, based on a frame header of the received marine data, whether the marine data is fragmented data, and if it is determined that the marine data is the fragmented data, waiting until a last frame of the marine data is received.

Sending the response message to the maritime IoT device may be configured to, when the marine data is not the fragmented data or when a frame of the received marine data is a last frame, send the response message to the maritime IoT device during a communication-available time corresponding to a subsequent period.

The marine data collection method may further include consecutively receiving sample data from the maritime IoT device, estimating at least one of phase information and period information of the maritime IoT device based on communication quality of the sample data, generating the communication-available time information of the maritime IoT device based on at least one of the estimated phase information and period information, and transmitting the generated communication-available time information to the maritime IoT device.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating an environment to which a maritime IoT device and a marine data collection apparatus according to an embodiment of the present invention are applied;

FIG. 2 is a block diagram illustrating the configuration of a maritime IoT device according to an embodiment of the present invention;

FIG. 3 is a block diagram illustrating the configuration of a marine data collection apparatus according to an embodiment of the present invention;

FIG. 4 is a flowchart illustrating a network connection setup process performed by the maritime IoT device according to an embodiment of the present invention;

FIG. 5 is a flowchart illustrating a marine data transmission method performed by the maritime IoT device according to an embodiment of the present invention;

FIG. 6 is a flowchart illustrating a network connection setup process performed by the marine data collection apparatus according to an embodiment of the present invention;

FIG. 7 is a flowchart illustrating a marine data collection method performed by the marine data collection apparatus according to an embodiment of the present invention;

FIG. 8 is a flowchart illustrating the process in which the marine data collection apparatus transmits communication-available time information to the maritime IoT device according to an embodiment of the present invention;

FIG. 9 is a diagram for explaining the communication radiation angle of the maritime IoT device according to an embodiment of the present invention;

FIG. 10 is a diagram for explaining upper/lower boundary points of the communication radiation angle of the maritime IoT device according to an embodiment of the present invention;

FIG. 11 is a diagram for explaining the location of the maritime IoT device depending on the phase of waves according to an embodiment of the present invention;

FIG. 12 is a diagram illustrating the process in which a marine data transmission/reception system transmits/receives unfragmented marine data according to an embodiment of the present invention;

FIG. 13 is a diagram illustrating the process in which the marine data transmission/reception system transmits/receives fragmented marine data according to an embodiment of the present invention; and

FIG. 14 is a block diagram illustrating a computer system according to an embodiment of the present invention.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and that they include all changes, equivalents or modifications included in the spirit and scope of the present invention.

The terms used in the present specification are merely used to describe specific embodiments, and are not intended to limit the present invention. A singular expression includes a plural expression unless a description to the contrary is specifically pointed out in context. In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Unless differently defined, all terms used here including technical or scientific terms have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings, and repeated descriptions of the same components will be omitted.

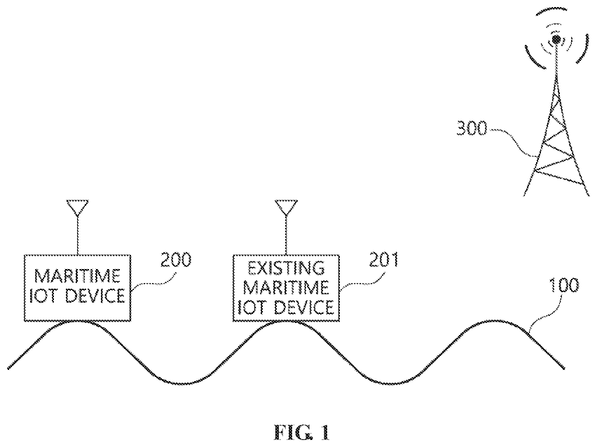

FIG. 1 is a diagram schematically illustrating an environment to which a maritime IoT device and a marine data collection apparatus according to an embodiment of the present invention are applied.

As illustrated in FIG. 1, a marine data transmission/reception system according to an embodiment of the present invention includes one or more maritime IoT devices 200 and 201 and one or more marine data collection apparatuses 300.

The maritime IoT devices 200 and 201 collect marine data and transmit the collected marine data to the marine data collection apparatuses 300. Here, the maritime IoT device 200 may refer to a maritime IoT device equipped with a wave-monitoring function according to an embodiment of the present invention, and the maritime IoT device 201 may be an existing maritime IoT device, which is legacy equipment not equipped with a wave-monitoring function.

In this way, in the marine data transmission/reception system, the maritime IoT device 200 equipped with a wave-monitoring function and the existing maritime IoT device 201 not equipped with a wave-monitoring function may be used together.

The maritime IoT devices 200 and 201 may be implemented to be installed on a buoy, a fishing net or the like or to float on the seawater, and may be installed at sea. Further, the maritime IoT devices 200 and 201 are characterized in that the phases thereof are changed depending on the movement of waves 100 and in that deterioration of communication performance may occur due to wind or the movement of waves.

Also, the maritime IoT devices 200 and 201 may be supplied with power either from an embedded battery or through a charging module, but the supply of energy is limited, and thus energy needs to be efficiently managed using energy-saving technology.

In order to solve this problem, the maritime IoT device 200 according to the embodiment of the present invention analyzes phase information and period information of waves using a wave-monitoring function, calculates a communication-available time using the phase information and the period information, and performs communication scheduling. Further, the maritime IoT device 200 may transmit the marine data to each marine data collection apparatus 300 within the communication-available time.

In contrast, when the maritime IoT device is the existing maritime IoT device 201 not equipped with a wave-monitoring function, the communication scheduling of the existing maritime IoT device 201 may be performed by the marine data collection apparatus 300 according to the embodiment of the present invention.

The marine data collection apparatus 300 may be installed on a land area such as the shore, or at sea, and may collect marine data from the one or more maritime IoT devices 200 and 201. Further, the marine data collection apparatus 300 may calculate information about the time during which communication with the maritime IoT device 200 is available based on the phase information and the period information received from the maritime IoT device 200, and may send messages to the maritime IoT device 200 during the communication-available time.

In contrast, when the marine data collection apparatus 300 receives marine data from the existing maritime IoT device 201, the marine data collection apparatus 300 may calculate phase information and period information, calculate information about the time during which communication with the existing maritime IoT device 201 is available, and perform communication with the existing maritime IoT device 201 during the calculated communication-available time.

That is, when the existing maritime IoT device 201 can neither calculate a communication-available time nor perform a communication-scheduling function, the marine data collection apparatus 300 generates the communication-available time information of the maritime IoT device 201 using consecutive sample data received from the maritime IoT device 201. Further, the marine data collection apparatus 300 may transmit the communication-available time information to the maritime IoT device 201, thus allowing the maritime IoT device 201 to transmit marine data during the communication-available time.

In this way, the marine data transmission/reception system including the maritime IoT devices 200 and 201 the marine data collection apparatus 300 according to the embodiment of the present invention may dynamically determine a method for accessing a communication medium depending on the period of waves or the distances between the maritime IoT devices 200 and 201 and the marine data collection apparatus 300, and may then perform communication suitable for the marine environment.

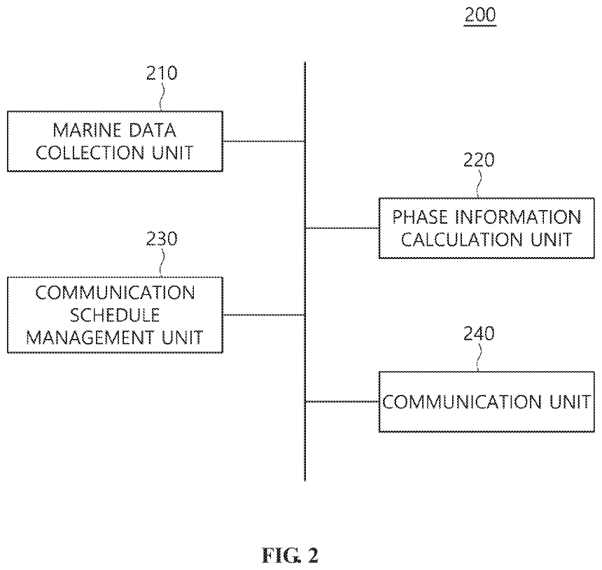

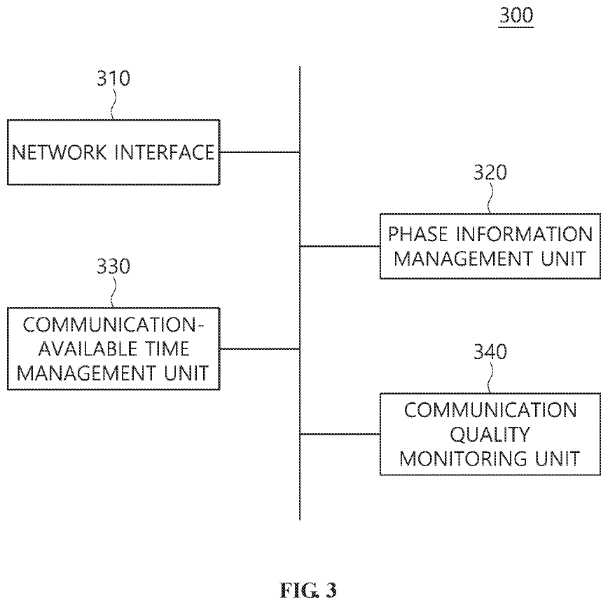

The configurations and functions of the maritime IoT device 200 and the marine data collection apparatus 300 will be described in greater detail below with reference to FIGS. 2 and 3.

Hereinafter, the configurations of a maritime IoT device and a marine data collection apparatus according to embodiments of the present invention will be described in detail with reference to FIGS. 2 and 3.

FIG. 2 is a block diagram illustrating the configuration of a maritime IoT device according to an embodiment of the present invention.

As illustrated in FIG. 2, a marine data collection unit 210 collects marine data including at least one of ocean state information and service application data using one or more sensors.

Although, in FIG. 2, the marine data collection unit 210 is illustrated as collecting the marine data for convenience of description, the configuration of the present invention is not limited thereto, and the marine data collection unit 210 may be composed of an ocean state information collection module for collecting ocean state information and a service application data collection module for collecting service application data.

The ocean state information collection module refers to a module for collecting ocean state information by performing wave monitoring to calculate the phase information of waves. The ocean state information collection module may collect ocean state information indicative of data about a marine environment using one or more of a tilt sensor, an acceleration sensor, and a gyroscope sensor.

Further, the service application data collection module may collect data needed for a service application, such as Global Positioning System (GPS) information, and may autonomously collect data using one or more sensors or receive data from additional modules.

Also, a phase information calculation unit 220 analyzes the collected marine data, and then generates phase information and period information of waves. The phase information calculation unit 220 may generate phase information and period information about the state of the marine environment, in which the maritime IoT device 200 is installed, using the collected ocean state information.

A communication schedule management unit 230 calculates, based on the phase information and the period information, communication-available time information indicating the time during which communication with the marine data collection apparatus 300 is available, that is, the time during which communication with the marine data collection apparatus 300 can be performed, and generates communication-scheduling information of the maritime IoT device 200 using the calculated communication-available time information.

Here, the communication schedule management unit 230 may calculate the communication-available time information based on at least one of the phase information of waves, the tilt of an antenna mounted on the maritime IoT device 200, and the height information of the marine data collection apparatus 300.

The communication schedule management unit 230 determines whether the marine data collection apparatus 300 falls within the range of the radiation angle of the maritime IoT device 200, based on the distance to the marine data collection apparatus 300 and the height information of the marine data collection apparatus 300. Also, the communication schedule management unit 230 may generate communication-scheduling information based on whether the marine data collection apparatus 300 falls within the range of the radiation angle.

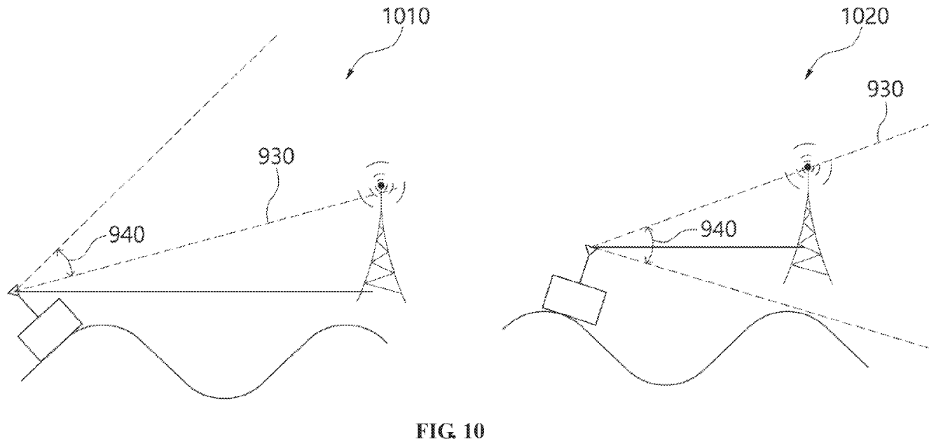

When the marine data collection apparatus 300 falls within a range from the upper boundary point to the lower boundary point of the radiation angle of the maritime IoT device 200, the communication schedule management unit 230 may determine that the maritime IoT device 200 is in a state enabling communication with the marine data collection apparatus 300. The procedure whereby the communication schedule management unit 230 determines whether the marine data collection apparatus 300 falls within the range of the radiation angle will be described in detail later with reference to FIG. 10.

Also, when the phase information indicates a top and the marine data collection apparatus falls within the range of the radiation angle, the communication schedule management unit 230 may determine the corresponding time to be the communication-available time, and may then generate communication-scheduling information.

Further, the communication schedule management unit 230 may generate the communication-scheduling information so that a transmission time, which is the time during which marine data is to be transmitted, is located at the center of the communication-available time. Furthermore, the communication schedule management unit 230 may set a period from the start time of the communication-available time to a time after the lapse of a guard time as the transmission time.

The communication schedule management unit 230 may generate the communication-scheduling information so as to wait for a message to be received from the marine data collection apparatus 300 for a reception-waiting time longer than the communication-available time.

Further, the communication schedule management unit 230 compares a required transmission time (Time on Air: ToA), which is the time required when desiring to transmit marine data to the marine data collection apparatus 300, with the communication-available time of the maritime IoT device 200. As a result of the comparison, when the required transmission time (ToA) is longer than the communication-available time, the communication schedule management unit 230 may fragment and transmit marine data desired to be transmitted to the marine data collection apparatus 300.

A communication unit 240 performs communication with the marine data collection apparatus 300. Here, the communication unit 240 may transmit the marine data to the marine data collection apparatus 300 during the communication-available time depending on the communication-scheduling information, and may wait for data to be received from the marine data collection apparatus 300. That is, the communication unit 240 may transmit a frame desired to be transmitted to the marine data collection apparatus 300 during a time designated by the communication-scheduling information.

The communication unit 240 may send a network connection request message including phase information and period information to the marine data collection apparatus 300 that is to transmit the marine data. Furthermore, the communication unit 240 may receive a network connection permission message, including at least one of the location information and height information of the marine data collection apparatus 300, from the marine data collection apparatus 300, and may then complete a network connection.

Also, the communication unit 240 may transmit the marine data to the marine data collection apparatus 300 based on the communication-scheduling information.

The communication-scheduling information may refer to information scheduled such that the maritime IoT device 200 transmits the marine data to the marine data collection apparatus 300 during the communication-available time. Further, the communication unit 240 may transmit the marine data to the marine data collection apparatus 300 or wait for the reception of data during the communication-available time based on the communication-scheduling information, and may enter a sleep mode for the remaining time other than the communication-available time, thus minimizing power consumption.

Further, when the marine data to be transmitted to the marine data collection apparatus 300 is fragmented into multiple marine data frames, the communication unit 240 may distribute and transmit the marine data frames during multiple communication-available times. That is, the communication unit 240 may transmit a first frame of the fragmented marine data to the marine data collection apparatus 300 during a first communication-available time, and may transmit data frames from a second frame during respective communication-available times corresponding to subsequent periods.

Although not illustrated in FIG. 2, the maritime IoT device 200 according to the embodiment of the present invention may further include a GPS module that is used to calculate the distance to the marine data collection apparatus 300 and a power supply unit that supplies limited power.

FIG. 3 is a block diagram illustrating the configuration of a marine data collection apparatus according to an embodiment of the present invention.

As illustrated in FIG. 3, the marine data collection apparatus 300 may include a network interface 310, a phase information management unit 320, a communication-available time management unit 330, and a communication quality monitoring unit 340.

The network interface 310 performs communication with one or more maritime IoT devices 200. The network interface 310 may receive a network connection request message from each maritime IoT device 200 and send a network connection permission message to a connection-permitted maritime IoT device 200.

Further, the network interface 310 receives marine data from the maritime IoT device 200 for which the network connection has been completed. Here, the marine data received by the network interface 310 may be either normal marine data that is unfragmented or marine data that is fragmented into multiple frames.

The network interface 310 may determine whether the corresponding marine data is fragmented data based on the frame header of the received marine data, and may wait until the last frame of the marine data is received if it is determined that the corresponding marine data is fragmented data.

Also, when the marine data is not fragmented data or when the frame of the received marine data is the last frame, the network interface 310 may send a response message to the maritime IoT device 200 during a communication-available time corresponding to a subsequent period.

Further, the network interface 310 may consecutively receive pieces of sample data from an existing maritime IoT device 201 having no function of generating phase information and period information of waves. Here, the network interface 310 may transmit communication-available time information of the existing maritime IoT device 201, generated by the communication-available time management unit 330, to the corresponding maritime IoT device 201.

The phase information management unit 320 may update and store prestored phase information and period information based on the information included in the network connection request message received from the maritime IoT device 200 or the marine data.

When the consecutive sample data is received from the existing maritime IoT device 201, the phase information management unit 320 may estimate at least one of phase information and period information of waves on the sea on which the existing maritime IoT device 201 is located, based on the communication quality of the sample data. Further, the phase information management unit 320 may update the prestored phase information and period information with the estimated phase information and period information, and may store the updated information.

The communication-available time management unit 330 may generate communication-scheduling information including communication-available time information, which indicates the time during which communication with the IoT device 200 is available, based on the phase information and the period information.

The marine data collection apparatus 300 according to the embodiment of the present invention may generate the communication-scheduling information so that the communication-scheduling information can be transmitted to the maritime IoT device 200 only when the location of the maritime IoT device 200 is at the top of waves and the marine data collection apparatus 300 falls within the range of a radiation angle of the maritime IoT device 200.

When the network interface 310 consecutively receives sample data from the maritime IoT device 200, the communication quality monitoring unit 340 monitors the communication quality of the sample data.

At this time, the communication quality of the sample data, monitored by the communication quality monitoring unit 340, may be used when the phase information management unit 320 estimates at least one of the phase information and the period information.

For convenience of description, the marine data collection apparatus 300 has been described as including the communication quality monitoring unit 340. However, the configuration of the present invention is not limited thereto, and may be modified such that, when all of the maritime IoT devices 200 constituting the marine data transmission/reception system are each equipped with a wave-monitoring function to calculate a communication-available time and perform communication scheduling, the marine data collection apparatus 300 may be implemented in a form in which the communication quality monitoring unit 340 is not included.

Also, although the configuration of the marine data collection apparatus 300 which performs communication with the maritime IoT device 200 equipped with a wave-monitoring function has been described, the marine data collection apparatus 300 may perform communication with the existing maritime IoT device 201 not equipped with a wave-monitoring function, and may generate the communication-scheduling information of the existing maritime IoT device 201. Further, the configuration of the marine data collection apparatus 300 which performs communication with the existing maritime IoT device 201 may be substantially identical or similar to that of FIG. 3, and repeated descriptions thereof will be omitted for convenience of description.

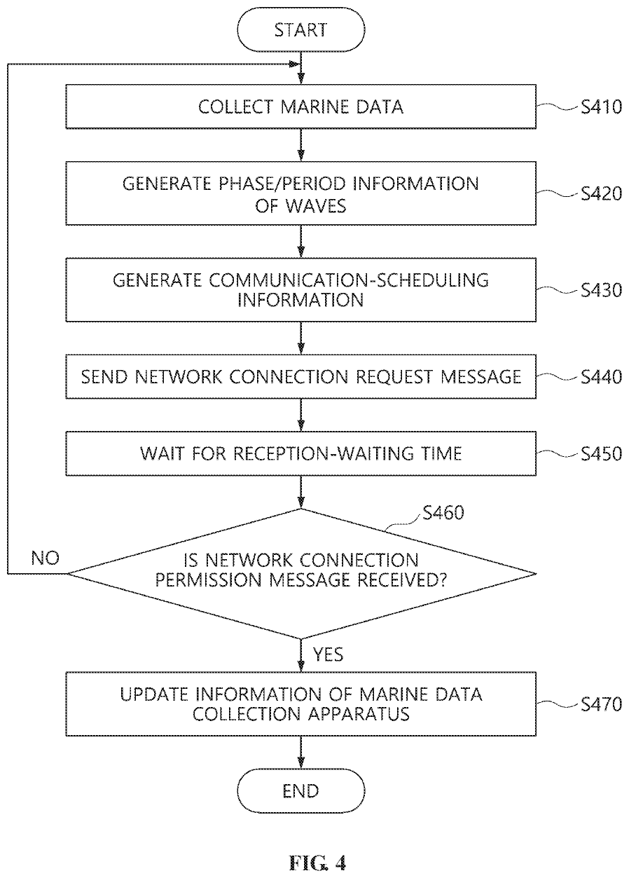

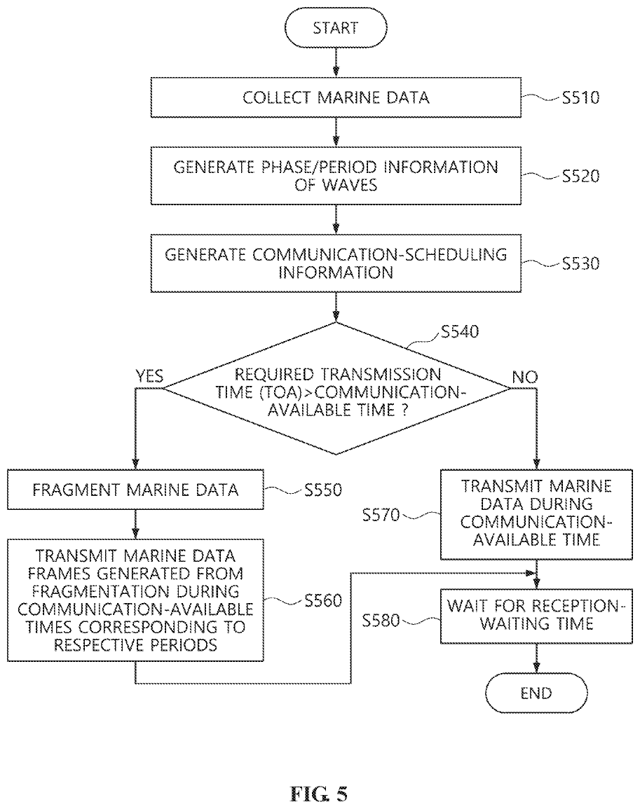

Hereinafter, the process in which a maritime IoT device according to an embodiment of the present invention sets up a network connection and transmits marine data will be described in detail with reference to FIGS. 4 and 5.

FIG. 4 is a flowchart illustrating a network connection setup process performed by the maritime IoT device according to an embodiment of the present invention.

First, the maritime IoT device 200 collects marine data at step S410.

The maritime IoT device 200 collects the marine data using one or more provided sensors. Here, all or part of the collected marine data is transmitted to a marine data collection apparatus 300, connected to a network through a process that will be described later.

Further, the maritime IoT device 200 generates phase information and period information of waves at step S420.

The maritime IoT device 200 may generate, using the collected marine data or data collected for wave monitoring, the phase information and period information of waves on the sea on which the maritime IoT device 200 is located.

Next, the maritime IoT device 200 generates communication-scheduling information based on the phase information and the period information at step S430.

The maritime IoT device 200 generates communication-scheduling information, by which the maritime IoT device 200 is to perform communication with the marine data collection apparatus 300, using the phase information and period information generated at step S420. The communication-scheduling information refers to information scheduled such that a message or data is sent to the marine data collection apparatus 300 during the communication-available time, indicating a period in which the maritime IoT device 200 corresponds to the location of the top of waves and the marine data collection apparatus 300 falls within the range of the radiation angle of the maritime IoT device 200.

The maritime IoT device 200 sends a network connection request message to the marine data collection apparatus 300 at step S440.

The maritime IoT device 200 sends the network connection request message to the marine data collection apparatus 300 during the communication-available time based on the communication-scheduling information. Here, the network connection request message may include the phase information and the period information generated at step S420.

The maritime IoT device 200 waits for a reception-waiting time at step S450.

Here, the reception-waiting time may be set in the communication-scheduling information, and may be longer than the communication-available time of the maritime IoT device 200.

When a network connection permission message is received from the marine data collection apparatus 300 for the reception-waiting time (the case of “Yes” at step S460), the maritime IoT device 200 updates the information of the marine data collection apparatus 300 at step S470.

The maritime IoT device 200 may receive a network connection permission message including at least one of the location information and height information of the marine data collection apparatus 300 from the marine data collection apparatus 300. Further, the maritime IoT device 200 may update the information of the marine data collection apparatus 300 with the location information and the height information of the marine data collection apparatus 300 included in the network connection permission message.

In contrast, when a network connection permission message is not received from the marine data collection apparatus 300 for the preset reception-waiting time, the maritime IoT device 200 may repeatedly perform the process of FIG. 4 for the network connection or may terminate the performance of the process of FIG. 4.

The process of FIG. 4 may be performed when a network connection between the maritime IoT device 200 and the marine data collection apparatus 300 is initially set up, and the maritime IoT device 200 and the marine data collection apparatus 300 may set up a network connection by performing the process of FIG. 4 before performing the process of FIG. 5.

FIG. 5 is a flowchart illustrating a marine data transmission method performed by the maritime IoT device according to an embodiment of the present invention.

First, the maritime IoT device 200 collects marine data at step S510, generates phase information and period information of waves at step S520, and generates communication-scheduling information based on the phase information and the period information at step S530.

The steps of the process in which the maritime IoT device 200 collects the marine data, generates the phase information and period information, and generates the communication-scheduling information based on the generated phase information and period information may be substantially identical to steps S410 to S430 of FIG. 4, and thus repeated descriptions thereof will be omitted for convenience of description. Here, the marine data collected by the maritime IoT device 200 at step S510 may be identical to or different from the marine data collected at step S410 of FIG. 4.

Next, the maritime IoT device 200 compares a required transmission time (i.e. Time on Air: ToA) of the marine data desired to be transmitted with the communication-available time of the maritime IoT device 200 at step S540.

The maritime IoT device 200 checks the required transmission time (ToA) of the marine data desired to be transmitted to the marine data collection apparatus 300. Here, the required transmission time (ToA) of the marine data denotes the time predicted to be taken when the maritime IoT device 200 transmits the marine data to the marine data collection apparatus 300.

In the case of high-speed communication, a message may be sent for a unit time on the order of several ms, but, in the case of Low-Power Wide-Area (LPWA) communication technology, a long time on the order of seconds may be required. Therefore, the maritime IoT device 200 may derive the required transmission time (ToA) of marine data suitable for the communication interface.

If, as a result of the comparison, it is determined that the required transmission time (ToA) of the marine data is longer than the communication-available time, the maritime IoT device 200 may fragment the marine data to be transmitted at step S550 and transmit marine data frames generated from the fragmentation to the marine data collection apparatus 300 during communication-available times corresponding to respective periods at step S560.

For example, when the required transmission time (ToA) of the marine data is 10 seconds and the communication-available time is 3 seconds, the maritime IoT device 200 may fragment the marine data into frames each having a length of 3 seconds or less, and may transmit the marine data frames generated from the fragmentation to the marine data collection apparatus 300 during respective communication-available times.

That is, the maritime IoT device 200 may generate four frames by fragmenting the marine data desired to be transmitted into units of 3 seconds, may transmit a first frame to the marine data collection apparatus 300 during the communication-available time that arrives first, and may transmit a second frame during the communication-available time that arrives after the lapse of a period. A third frame and a fourth frame may also be transmitted to the marine data collection apparatus 300 during respective communication-available times that arrive after the lapse of the corresponding periods.

When transmitting the fragmented marine data to the marine data collection apparatus 300 at step S560, the maritime IoT device 200 may set the fragment bit of a frame header to ON and transmit the marine data in order to notify the marine data collection apparatus 300 that the transmitted marine data has been fragmented.

Also, the maritime IoT device 200 may set the fragment bit of a frame header to OFF and transmit the marine data in order to notify the marine data collection apparatus 300 that the transmitted marine data is unfragmented data or that the corresponding frame is the last frame.

In contrast, when the ToA of the marine data is shorter than or equal to the communication-available time, the maritime IoT device 200 transmits the marine data to the marine data collection apparatus 300 during the communication-available time at step S570.

If, as a result of the comparison between the required transmission time (ToA) of the marine data and the communication-available time of the communication-scheduling information, it is determined that the ToA of the marine data is shorter than the communication-available time, the maritime IoT device 200 may transmit the corresponding marine data to the marine data collection apparatus 300 within the communication-available time, without fragmenting the marine data.

For example, when the ToA of the marine data is 3 seconds and the communication-available time is 5 seconds, the marine data may be transmitted to the marine data collection apparatus 300 within the communication-available time. Therefore, the maritime IoT device 200 may transmit the marine data to the marine data collection apparatus 300 without fragmenting the marine data.

After the marine data has been transmitted at step S560 or S570, the maritime IoT device 200 may wait for a message to be received from the marine data collection apparatus 300 for a reception-waiting time at step S580.

The reception-waiting time at step S580 may be substantially identical to the reception-waiting time at step S450 of FIG. 4, and the maritime IoT device 200 may receive a response message indicating that the reception of the marine data from the marine data collection apparatus 300 has been completed within the reception-waiting time.

When the reception-waiting time has elapsed, the maritime IoT device 200 may set the communication unit to a sleep mode, thus minimizing power consumption. Here, the maritime IoT device 200 may set the maritime IoT device 200 itself, as well as the communication unit, to the sleep mode, and may wake up and set the communication unit (or the maritime IoT device 200) to an active mode when a predetermined period has elapsed and then the communication-available time arrives.

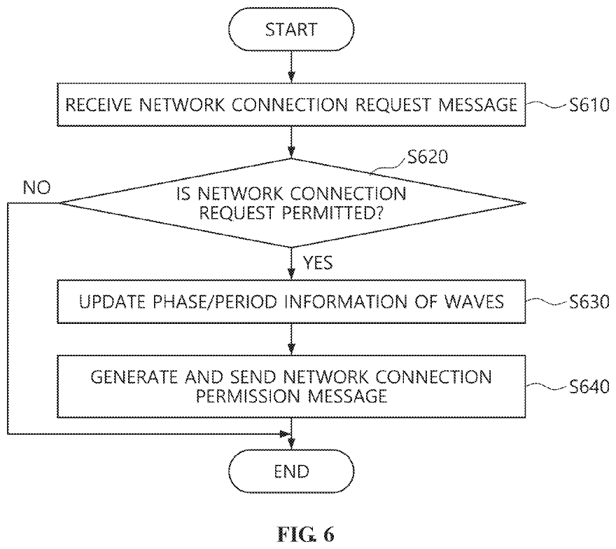

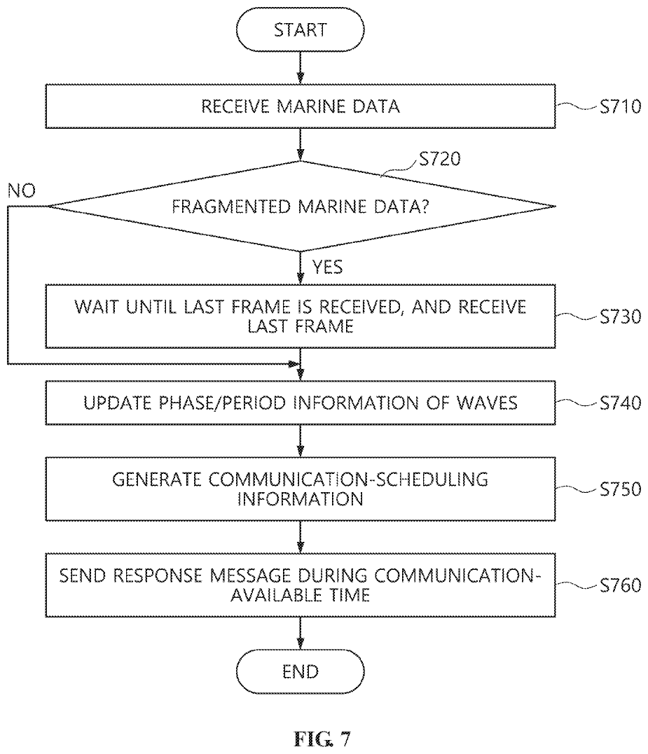

Hereinafter, the process in which a marine data collection apparatus according to an embodiment of the present invention sets up a network connection and receives marine data will be described in detail with reference to FIGS. 6 and 7.

FIG. 6 is a flowchart illustrating a network connection setup process performed by the marine data collection apparatus according to an embodiment of the present invention.

First, the marine data collection apparatus 300 receives a network connection request message from a maritime IoT device 200 at step S610. Also, the marine data collection apparatus 300 determines whether to permit a network connection request for the maritime IoT device 200 that sent the network connection request message.

The marine data collection apparatus 300 determines whether to permit network connection by the maritime IoT device 200 that sent the network connection request message at step S620.

Here, if it is determined not to permit network connection (the case of “No” at step S620), the marine data collection apparatus 300 may send a message indicating that network connection has been disapproved to the corresponding maritime IoT device 200, or may terminate the performance of the process of FIG. 6.

In contrast, if it is determined to permit the network connection request (the case of “Yes” at step S620), the marine data collection apparatus 300 may update at least one of phase information and period information of waves based on the data included in the network connection request message at step S630.

At step S610, the marine data collection apparatus 300 may receive a network connection request message including at least one of the phase information and the period information of waves. Further, the marine data collection apparatus 300 may store the phase information and the period information of waves, included in the network connection request message of the maritime IoT device 200 for which network connection has been permitted, in a database (DB) managed for each maritime IoT device, and may update prestored phase information and period information.

Finally, the marine data collection apparatus 300 may generate a network connection permission message and send the same to the maritime IoT device 200 at step S640.

The marine data collection apparatus 300 may calculate a communication-available time of the maritime IoT device 200 based on the phase information and period information of waves received from the maritime IoT device 200, and may send the network connection permission message to the maritime IoT device 200 during the corresponding communication-available time.

FIG. 7 is a flowchart illustrating a marine data collection method performed by the marine data collection apparatus according to an embodiment of the present invention.

First, the marine data collection apparatus 300 receives marine data from one or more maritime IoT devices 200 at step S710.

The marine data collection apparatus 300 may receive the marine data from each maritime IoT device 200 for which network connection has been completed. Here, the received marine data may be data transmitted by the maritime IoT device 200 to the marine data collection apparatus 300 at step S570 or S560 of FIG. 5.

Next, the marine data collection apparatus 300 determines whether the received marine data is fragmented marine data at step S720.

The marine data collection apparatus 300 may determine whether the received marine data is fragmented marine data by checking a frame header of the received marine data. Here, when a fragment bit of the frame header is set to ON, the marine data collection apparatus 300 may determine that the marine data is fragmented marine data, whereas when the fragment bit of the frame header is set to OFF, the marine data collection apparatus 300 may determine that the marine data is unfragmented marine data or that the corresponding frame is the last frame of fragmented marine data.

If it is determined that the received marine data is the fragmented marine data, the marine data collection apparatus 300 may wait until the last frame is received, and may then receive all frames of the fragmented marine data at step S730.

Here, the marine data collection apparatus 300 may determine whether the received marine data is the last frame of the marine data by checking the frame header of the received marine data, and may wait until the last frame, which is marine data in which the fragment bit is set to OFF, is received.

In contrast, when the received marine data is not fragmented marine data, or when the reception of the last frame has been completed, the marine data collection apparatus 300 may update the phase information and period information of waves based on the received marine data.

Further, the marine data collection apparatus 300 may generate communication-scheduling information based on at least one of the phase information and the period information at step S750, and may send a response message to the maritime IoT device 200 during a communication-available time corresponding to the communication-scheduling information at step S760.

The marine data collection apparatus 300 may wait until the communication-available time, which is a period during which the maritime IoT device 200 is capable of receiving the response message, and may send the response message to the maritime IoT device 200 during the communication-available time.

For convenience of description, the maritime IoT device 200 has been described as including the phase information calculation unit 220 and the communication schedule management unit 230, calculating the communication-available time by monitoring waves, and generating the communication-scheduling information.

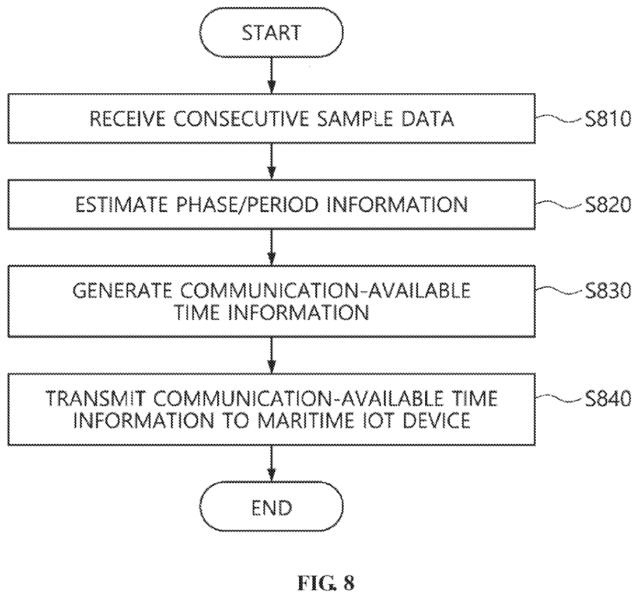

However, the present invention is not limited thereto, and the marine data collection apparatus 300 according to the embodiment of the present invention may receive marine data from an existing maritime IoT device 201, which does not include a component for monitoring waves or a component for calculating a communication-available time. In this case, the marine data collection apparatus 300 may calculate the communication-available time and generate communication-scheduling information as illustrated in FIG. 8.

FIG. 8 is a flowchart illustrating the process in which the marine data collection apparatus transmits communication-available time information to a maritime IoT device according to an embodiment of the present invention.

First, the marine data collection apparatus 300 receives consecutive sample data from the existing maritime IoT device 201 at step S810.

The marine data collection apparatus 300 may receive consecutive sample data from the existing maritime IoT device 201, which is not equipped with a wave-monitoring function. By means of this operation, the marine data collection apparatus 300 according to the embodiment of the present invention may calculate phase information and period information in place of the existing maritime IoT device 201 through the process of FIG. 8, and may perform communication scheduling by calculating a communication-available time of the existing maritime IoT device 201.

Also, the marine data collection apparatus 300 may estimate the phase information and period information of waves using the sample data at step S820, and may generate communication-available time information of the existing maritime IoT device 201 at step S830.

The marine data collection apparatus 300 monitors communication quality using the sample data received from the existing maritime IoT device 201, and estimates the phase information and period information of waves based on the communication quality of the sample data.

Further, the marine data collection apparatus 300 may generate communication-available time information of the existing maritime IoT device 201 using the estimated phase information and period information, and may generate the communication-scheduling information of the existing maritime IoT device 201.

Next, the marine data collection apparatus 300 may transmit the communication-available time information to the existing maritime IoT device 201 at step S840.

The marine data collection apparatus 300 transmits the communication-scheduling information, including the communication-available time information generated at step S830, to the existing maritime IoT device 201. Further, the existing maritime IoT device 201 may synchronize a communication period depending on the received communication-scheduling information.

Furthermore, if necessary, the existing maritime IoT device 201 may request the marine data collection apparatus 300 to generate communication-scheduling information, and the marine data collection apparatus 300 requested to generate the communication-scheduling information may transmit communication-scheduling information to the existing maritime IoT device 201 by performing the process of FIG. 8.

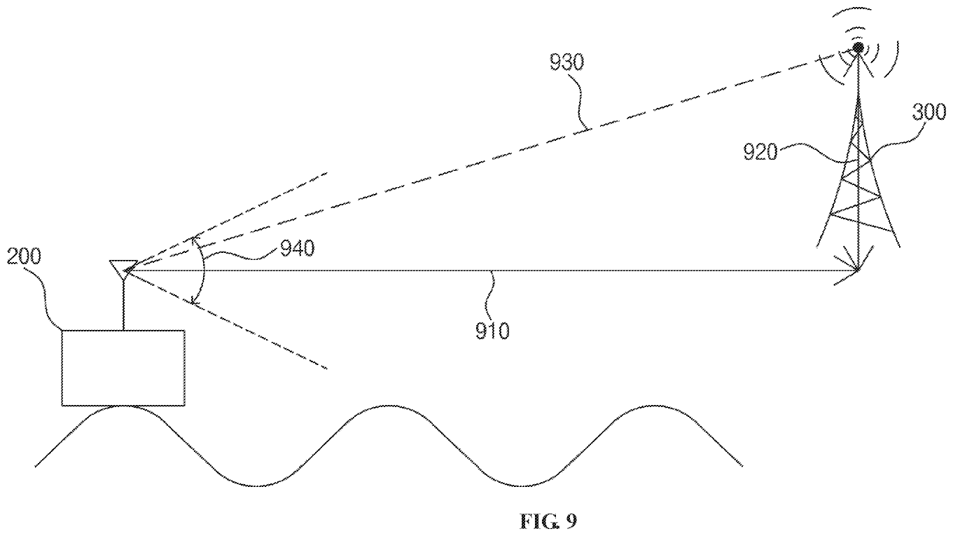

Hereinafter, a method for setting the communication-available time of a maritime IoT device according to embodiments of the present invention will be described in detail with reference to FIGS. 9 to 11.

FIG. 9 is a diagram for explaining a communication radiation angle of a maritime IoT device according to an embodiment of the present invention.

As illustrated in FIG. 9, a connection line 930 between the maritime IoT device 200 and the marine data collection apparatus 300 is checked using a distance 910 between the maritime IoT device 200 and the marine data collection apparatus 300 and the height 920 of the marine data collection apparatus 300.

Here, information about the distance 910 between the maritime IoT device 200 and the marine data collection apparatus 300 and the height 920 of the marine data collection apparatus 300 may be shared through a procedure in which the maritime IoT device 200 requests network connection or a procedure for periodically updating state information.

Further, the maritime IoT device 200 determines whether the connection line 930 falls within the range of the radiation angle 940 of the maritime IoT device 200.

In a marine environment, deterioration of communication performance occurs depending on wind or the phase of waves. Accordingly, in order to guarantee stable communication of the maritime IoT device 200, communication must be performed at the moment at which the connection line 930 between the maritime IoT device 200 and the marine data collection apparatus 300 is aligned with the radiation direction of the antenna of the maritime IoT device 200.

That is, the maritime IoT device 200 may generate communication-scheduling information by setting a period during which the connection line 930 falls within the range of the radiation angle 940 in the radiation direction of the antenna as the communication-available time.

FIG. 10 is a diagram for explaining upper/lower boundary points of the communication radiation angle of the maritime IoT device according to an embodiment of the present invention.

FIG. 10 illustrates the case 1010 where a connection line 930 between the maritime IoT device 200 and the marine data collection apparatus 300 is located at a lower boundary point of the radiation angle and the case 1020 where the connection line 930 is located at an upper boundary point of the radiation angle.

Further, the maritime IoT device 200 may perform communication scheduling so that communication with the marine data collection apparatus 300 is performed while the connection line 930 is being located between the lower boundary point and the upper boundary point depending on the movement of waves. That is, the maritime IoT device 200 may generate communication-available time information by calculating the time during which the connection line 930 is located between the lower boundary point and the upper boundary point.

For convenience of description, an example in which the time during which the connection line 930 is located between the lower boundary point and the upper boundary point is determined to be the communication-available time has been described. However, this is configured to determine whether the marine data collection apparatus 300 falls within the range of a radiation angle 940, and this configuration may be implemented by changing a design using various methods for determining whether the marine data collection apparatus 300 falls within the range of the radiation angle 940.

Generally, the maritime IoT device 200 may be implemented in the form of a small-sized IoT device, the antenna direction or angle of which cannot be adjusted, and the antenna provided in the maritime IoT device 200 may be either a nondirectional (omnidirectional) antenna that enables omnidirectional communication or a multi-directional antenna that selectively exploits a specific direction. Furthermore, the marine data collection apparatus 300 may perform communication using a directional antenna, the direction or angle of which can be adjusted.

In the case of the omnidirectional antenna of the maritime IoT device 200, omnidirectional communication is possible, but there is a vertical communication radiation angle forming a round doughnut shape, and thus communication performance is rapidly deteriorated when the maritime IoT device 200 falls out of the communication range. Further, in the case of the multi-directional antenna, the radiation angle may be decreased in order to improve communication performance in a selected direction.

Therefore, in order to overcome the limitation of the maritime IoT device 200, the maritime IoT device 200 according to the embodiment of the present invention may generate communication-available time information by performing a wave-monitoring function, and may stably perform communication with the marine data collection apparatus 300 by performing communication scheduling based on the communication-available time information.

Although, for convenience of description, the case where the maritime IoT device 200 performs a wave-monitoring function and directly generates communication-scheduling information has been described by way of example, the present invention is not limited thereto. In detail, when the marine data collection apparatus 300 generates communication-scheduling information, the marine data collection apparatus 300 may determine whether the connection line 930 falls within the range of the radiation angle 940, and may then generate the communication-available time information of the maritime IoT device 200.

Meanwhile, even if the connection line 930 falls within the range of the radiation angle 940 of the maritime IoT device 200, the maritime IoT device 200 cannot stably perform communication when the phase of waves corresponding to the maritime IoT device 200 is at the bottom.

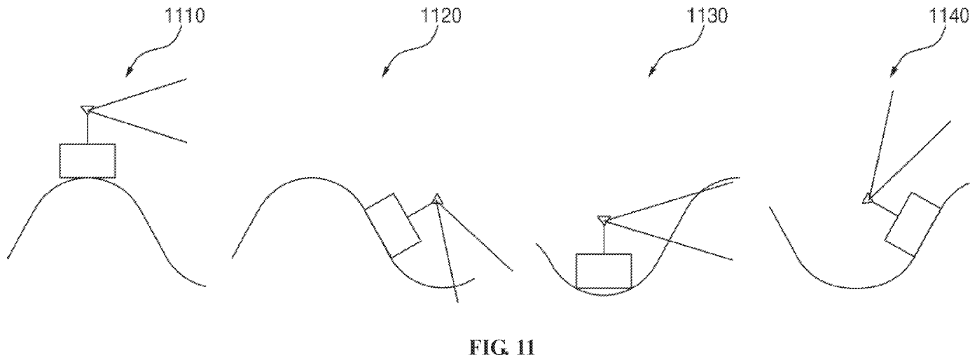

FIG. 11 is a diagram for explaining the location of the maritime IoT device depending on the phase of waves according to an embodiment of the present invention.

As illustrated in FIG. 11, the locations of the maritime IoT device 200 may be fragmented into the case where the maritime IoT device 200 is positioned at a top location 1110, the case where the maritime IoT device 200 is positioned at a falling (up/down) location 1120, the case where the maritime IoT device 200 is positioned at a bottom location 1130, and the case where the maritime IoT device 200 is positioned at a rising (down/up) location 1140.

In the case where the maritime IoT device 200 is positioned at an inclined surface of a wave, that is, at the falling (up/down) location 1120 and the rising (down/up) location 1140, the marine data collection apparatus 300 does not fall within a range defined by the radiation direction of the antenna of the maritime IoT device 200, and thus communication with the marine data collection apparatus 300 is impossible.

In contrast, in the case where the maritime IoT device 200 is positioned at the top location 1110 or the bottom location 1130, at which the maritime IoT device 200 is located on the same horizontal line as the marine data collection apparatus, the marine data collection apparatus 300 may fall within the range of the radiation angle of the maritime IoT device 200. However, in the case of the bottom location 1130, it may be difficult for the maritime IoT device 200 to perform communication with the marine data collection apparatus 300 due to high waves.

Therefore, the maritime IoT device 200 according to the embodiment of the present invention may set the case where the phase of the wave is at the top and the connection line 930 falls within the range of the radiation angle 940 of the maritime IoT device 200 as the case where communication with the marine data collection apparatus 300 is available, thus improving stability in mutual communication.

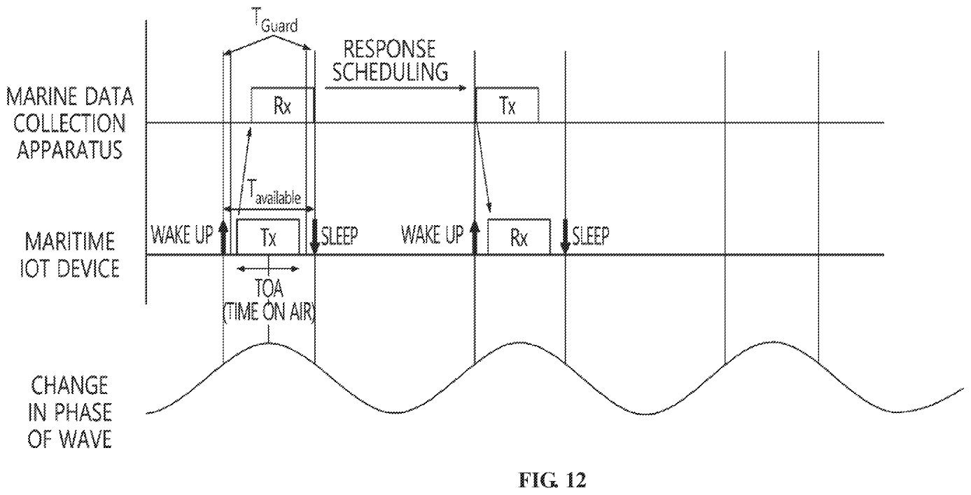

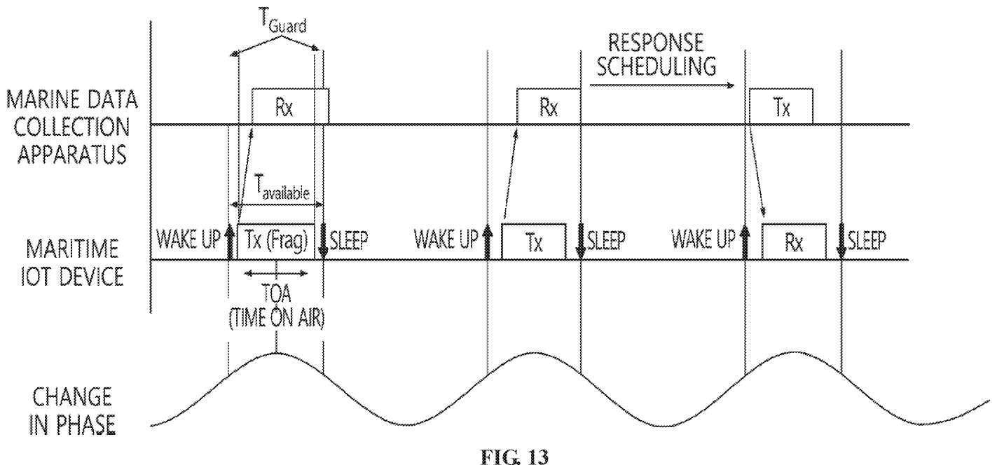

Hereinafter, the process in which a marine data transmission/reception system including a maritime IoT device and a marine data collection apparatus according to embodiments of the present invention transmits/receives marine data will be described in detail with reference to FIGS. 12 and 13.

FIG. 12 is a diagram illustrating the process in which the marine data transmission/reception system according to an embodiment of the present invention transmits/receives unfragmented marine data.

As illustrated in FIG. 12, if it is determined that the transmission of marine data is possible within a communication-available time, that is, if the communication-available time is longer than the required transmission time (Time on Air: ToA) of the marine data, the maritime IoT device 200 schedules the marine data without fragmenting the marine data, and transmits the marine data to the marine data collection apparatus 300.

Here, the maritime IoT device 200 may perform communication scheduling so that a time T_{Tx} during which marine data is to be transmitted (Tx) is located at the center of a communication-available time T_{available}. In this case, communication guard times T_{guard} may be set for the start and end of the communication-available time, and thus communication stability may be improved.

Next, the maritime IoT device 200 may switch a communication module to a sleep mode during the remaining time other than the predicted time in which communication is to be performed, thus minimizing power consumption, and may wake up the communication module during the predicted time in which communication is to be performed.

In this case, when an interval between the time required for switching to the sleep mode and the wake-up time is shorter than a preset time, the maritime IoT device 200 may be maintained in an active state, thus preventing the time required for wake up from being delayed.

Although the embodiment in which communication scheduling is performed such that the time T_{Tx} during which the marine data is to be transmitted is located at the center of the communication-available time T_{available} has been described for convenience of description, the present invention is not limited thereto. In detail, it is possible to implement the configuration such that, in the communication-available time T_{available}, a time after the lapse of the preset communication guard time T_{guard} may be set as the time T_{Tx} during which marine data is to be transmitted. Further, when communication quality is better in an early stage or a later stage of the communication-available time T_{available}, the time having better communication quality may be set as the time T_{Tx} during which the marine data is to be transmitted.

FIG. 13 is a diagram illustrating the process in which the marine data transmission/reception system according to the embodiment of the present invention transmits/receives fragmented marine data.

As illustrated in FIG. 13, when it is determined that it is impossible to transmit marine data within a communication-available time, that is, when the communication-available time is shorter than the ToA of the marine data, the maritime IoT device 200 may fragment the marine data and transmit marine data frames generated from the fragmentation to the marine data collection apparatus 300.

The maritime IoT device 200 may notify the marine data collection apparatus 300 that the marine data has been fragmented through a first frame of the marine data to be transmitted to the marine data collection apparatus 300. Here, the maritime IoT device 200 may transmit the marine data in which a fragment bit of a frame header is set to ON.

Further, the marine data collection apparatus 300, having received the marine data in which the fragment bit is set to ON, waits until the last frame of the marine data, in which the fragment bit is set to OFF, is received. Then, when the last frame is received, the marine data collection apparatus 300 may process the received marine data, and may generate a response message indicating that the marine data has been received and send the response message to the maritime IoT device 200.

The marine data collection apparatus 300 may wait for the maritime IoT device 200 to send a message for a time longer than the communication-available time of the maritime IoT device 200, and the waiting time of the marine data collection apparatus 300 may be increased through previous setting.

Further, the marine data collection apparatus 300 may send a response message to the maritime IoT device 200 during a communication-available time corresponding to a subsequent period so that the maritime IoT device 200 can stably receive the message.

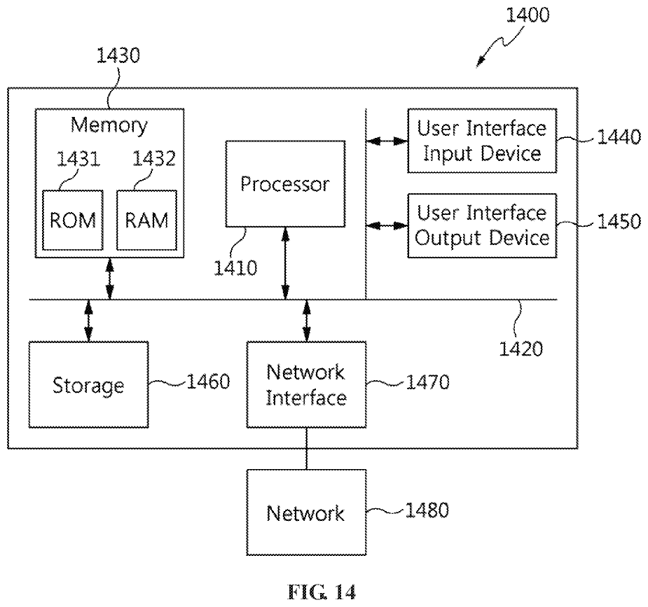

FIG. 14 is a block diagram illustrating a computer system according to an embodiment of the present invention.

Referring to FIG. 14, the embodiment of the present invention may be implemented in a computer system 1400 such as a computer-readable storage medium. As illustrated in FIG. 14, the computer system 1400 may include one or more processors 1410, memory 1430, a user interface input device 1440, a user interface output device 1450, and storage 1460, which communicate with each other through a bus 1420. The computer system 1400 may further include a network interface 1470 connected to a network 1480. Each processor 1410 may be a Central Processing Unit (CPU) or a semiconductor device for executing processing instructions stored in the memory 1430 or the storage 1460. Each of the memory 1430 and the storage 1460 may be any of various types of volatile or nonvolatile storage media. For example, the memory 1430 may include Read-Only Memory (ROM) 1431 or Random Access Memory (RAM) 1432.

Therefore, the embodiment of the present invention may be implemented as a non-transitory computer-readable medium in which a computer-implemented method is recorded or in which computer-executable instructions are recorded. When the computer-executable instructions are executed by the processor, the instructions may perform the method according to at least one aspect of the present invention.

In accordance with the present invention, the problem of deterioration of communication performance attributable to wind or the movement of waves in a marine environment may be solved, and a stable maritime communication environment may be constructed.

Further, in accordance with the present invention, stable communication of a maritime IoT device may be supported, and the energy efficiency of the maritime IoT device may be improved.

Furthermore, in accordance with the present invention, a method for accessing a communication medium may be dynamically determined depending on the state of a marine environment, and communication scheduling may then be performed.

Furthermore, in accordance with the present invention, maritime IoT devices that do not have a wave-monitoring function and a communication-scheduling function may also perform data transmission/reception suitable for a marine environment in which the movement of waves is great.

In addition, in accordance with the present invention, the energy of a maritime IoT device may be efficiently managed by setting the communication schedule of the maritime IoT device.

As described above, in the marine data collection apparatus, the maritime IoT device, and the marine data transmission method according to the present invention, the configurations and schemes in the above-described embodiments are not limitedly applied, and some or all of the above embodiments can be selectively combined and configured so that various modifications are possible.

What is claimed is:

1. A maritime Internet-of-Things (IoT) device, comprising:
a marine data collection unit for collecting marine data including at least one of ocean state information and service application data using one or more sensors;
a phase information calculation unit for analyzing the collected marine data and then generating phase information and period information of waves;
a communication schedule management unit for generating communication-scheduling information including communication-available time information, which indicates a time during which communication with a marine data collection apparatus is available, based on the phase information and the period information; and
a communication unit for transmitting the marine data including at least one of the ocean state information and the service application data to the marine data collection apparatus during the communication-available time.

2. The maritime IoT device of claim 1, wherein the communication schedule management unit determines, based on a distance to the marine data collection apparatus and height information of the marine data collection apparatus, whether the marine data collection apparatus falls within a range of a radiation angle of the maritime IoT device, and generates the communication-scheduling information based on whether the marine data collection apparatus falls within the range of the radiation angle.

3. The maritime IoT device of claim 2, wherein the communication schedule management unit is configured to, when the phase information of waves indicates a top and the marine data collection apparatus falls within the range of the radiation angle, determine that a corresponding time is the communication-available time.

4. The maritime IoT device of claim 1, wherein the communication schedule management unit is configured to compare a required transmission time, which is a time required in order to transmit the marine data, with the communication-available time after generation of the communication-scheduling information, and to fragment the marine data when the required transmission time is longer than the communication-available time.

5. The maritime IoT device of claim 4, wherein the communication unit transmits a first frame of the fragmented marine data during the communication-available time and transmits remaining fragmented marine data after the first frame during a communication-available time corresponding to a subsequent period.

6. The maritime IoT device of claim 5, wherein the communication schedule management unit generates the communication-scheduling information such that a transmission time that is a time during which the marine data is to be transmitted is located at a center of the communication-available time, or sets the transmission time to a time after lapse of a guard time from the communication-available time.

7. The maritime IoT device of claim 1, wherein the communication schedule management unit waits for data to be received from the marine data collection apparatus for a reception-waiting time including the communication-available time.

8. The maritime IoT device of claim 2, wherein the communication unit sends a network connection request message including the phase information and the period information to the marine data collection apparatus to which the marine data is to be transmitted, and receives a network connection permission message including at least one of location information and the height information of the marine data collection apparatus from the marine data collection apparatus.

9. A marine data collection apparatus, comprising:
a network interface for receiving marine data including at least one of ocean state information and service application data from a maritime Internet-of-Things (IoT) device;
a phase information management unit for updating phase information and period information of waves based on the ocean state information included in the marine data; and
a communication-available time management unit for generating communication-scheduling information including communication-available time information, which indicates a time during which communication with the maritime IoT device is available, based on the phase information and the period information.

10. The marine data collection apparatus of claim 9, wherein the network interface waits until a last frame of the marine data is received when the marine data is fragmented data as a result of determining, based on a frame header of the received marine data, whether the marine data is the fragmented data.

11. The marine data collection apparatus of claim 10, wherein the network interface is configured to, when the marine data is not the fragmented data or when a frame of the received marine data is a last frame, send a response message to the maritime IoT device during a communication-available time corresponding to a subsequent period.

12. The marine data collection apparatus of claim 9, further comprising a communication quality monitoring unit for, when the network interface consecutively receives sample data from the maritime IoT device, monitoring communication quality of the sample data so as to estimate at least one of phase information and period information of the maritime IoT device,
wherein the network interface transmits the communication-available time information of the maritime IoT device, generated by the communication-available time management unit based on at least one of the estimated phase information and period information, to the maritime IoT device.

13. A marine data transmission method performed by a maritime IoT device, comprising:
collecting marine data including at least one of ocean state information and service application data using one or more sensors;
analyzing the collected marine data and then generating phase information and period information of waves;
generating communication-scheduling information including communication-available time information, which indicates a time during which communication with a marine data collection apparatus is available, based on the phase information and the period information; and
transmitting the marine data including at least one of the ocean state information and the service application data to the marine data collection apparatus during the communication-available time.

14. The marine data transmission method of claim 13, wherein generating the communication-scheduling information comprises:
determining, based on a distance to the marine data collection apparatus and height information of the marine data collection apparatus, whether the marine data collection apparatus falls within a range of a radiation angle of the maritime IoT device; and
generating the communication-scheduling information based on whether the marine data collection apparatus falls within the range of the radiation angle.

15. The marine data transmission method of claim 14, wherein generating the communication-scheduling information is configured to, when the phase information of waves indicates a top and the marine data collection apparatus falls within the range of the radiation angle, determine that a corresponding time is the communication-available time.

16. The marine data transmission method of claim 13, further comprising:
comparing a required transmission time, which is a time required in order to transmit the marine data, with the communication-available time after generation of the communication-scheduling information; and
fragmenting the marine data when the required transmission time is longer than the communication-available time.

17. The marine data transmission method of claim 16, wherein transmitting the marine data is configured to transmit a first frame of the fragmented marine data during the communication-available time and transmit remaining fragmented marine data after the first frame during a communication-available time corresponding to a subsequent period.

18. The marine data transmission method of claim 17, wherein generating the communication-scheduling information is configured to generate the communication-scheduling information such that a transmission time that is a time during which the marine data is to be transmitted is located at a center of the communication-available time or to set the transmission time to a time after lapse of a guard time from the communication-available time.

19. The marine data transmission method of claim 13, further comprising waiting for data to be received from the marine data collection apparatus for a reception-waiting time including the communication-available time.

20. The marine data transmission method of claim 14, further comprising:
sending a network connection request message including the phase information and the period information to the marine data collection apparatus to which the marine data is to be transmitted; and
receiving a network connection permission message including at least one of location information and the height information of the marine data collection apparatus from the marine data collection apparatus.
